(19) United States
(12) Patent Application Publication
(10) Pub. No.: US 2024/0378069 A1
(43) Pub. Date: Nov. 14, 2024

(54) LOCALIZING A REMOTE DESKTOP

(71) Applicant: VMware, Inc., Palo Alto, CA (US)

(72) Inventor: Lin LV, Beijing (CN)

(73) Assignee: VMware, Inc., Palo Alto, CA (US)

(21) Appl. No.: 18/144,253

(22) Filed: May 8, 2023

(51) Int. Cl. G06F 9/455

(52) U.S. Cl. CPC G06F 9/45554; G06F 9/45558; G06F 2009/45595

(57) ABSTRACT

A remote desktop may be localized to a local operating system (OS), such that remote applications and remote files are accessible via the local OS, without having to launch a remote desktop client that renders a user interface (UI) for connection with the remote desktop. The remote desktop client runs in a background as one or more services without any UI. A user may access and use remote applications/files via the same UIs of the local OS that are used to access and use local applications/files.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC). For example, through server virtualization, virtualized computing instances such as virtual machines (VMs) running different operating systems (OSs) may be supported by the same physical machine (e.g., referred to as a host). Each virtual machine is generally provisioned with virtual resources to run an operating system and applications. The virtual resources in a virtualized computing environment may include central processing unit (CPU) resources, memory resources, storage resources, network resources, etc.

One example use of a virtualized computing environment is for a virtual desktop infrastructure (VDI) implementation, which is a type of desktop virtualization that allows a remote desktop to run on VMs that are provided by a hypervisor on a host. A user/client uses the remote operating system (OS) and remote applications (which reside and execute at the VM) via an endpoint device (local client device or local user device) of the user, just as if the remote OS/applications were actually running locally on the endpoint device along with local OS/applications, when in reality the remote OS/applications are running on the remote desktop.

Working remotely on a regular or occasional basis, such as via remote desktops rendered on laptops (or other endpoint device), has become common due to the flexibility and convenience. However, it can be difficult and inefficient for a user to concurrently work with remote files/applications and local files/applications.

### BRIEF DESCRIPTION OF DRAWINGS

FIG. 1 is a schematic diagram illustrating an example virtualized computing environment that can implement a virtual desktop infrastructure (VDI) having capability to enable the localization of a remote desktop;

FIG. 2 is a schematic diagram illustrating client and agent devices for the virtualized computing environment of FIG. 1;

FIG. 3 is a diagram illustrating an example of local desktop windows and remote desktop windows being presented on a display screen;

FIG. 4 shows an example user interface window that may be used to select remote applications for localization;

FIG. 5 shows an example user interface window that may be provided by a local OS to enable a localized remote application to open a local file;

FIG. 6 shows an example user interface window that may be provided by a local OS to enable searching for a remote application that has been localized;

FIG. 7 shows an example user interface window that may be provided by a local OS to display remote drives/folders as local drives/folders;

FIG. 8 shows an example user interface window that may be provided by a local OS to enable selection of a localized remote desktop on which a local file can be opened;

FIG. 9 is a diagram illustrating an example of a local desktop having a localized remote application rendered on a display screen;

FIG. 10 is a schematic diagram illustrating modules of a client and agent that cooperate to enable the localization of a remote desktop; and

FIGS. 11 and 12 are flow diagrams of an example method to localize a remote desktop at a client side.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

The present disclosure addresses drawbacks associated with concurrently using remote files/applications provided by a remote desktop and local files/applications provided by a local desktop. The techniques disclosed herein attempt to blur the boundaries between the local desktop and the remote desktop, a local application and a remote application, and a local file and a remote file, such that the user experience is advantageously more seamless, in that a user can use remote files and remote applications just as if the user is using local files and local applications.

For example and to further describe existing drawbacks in detail, a user may first launch a remote desktop client (installed on the user's local client device) in order to request access to a remote desktop provided by a virtual desktop infrastructure (VDI). The user logs into a connection server using the user's credentials, and connects to one of the remote desktops if the login is successful. When operating the remote desktop. the user may open and use remote files and remote applications installed on the remote desktop.

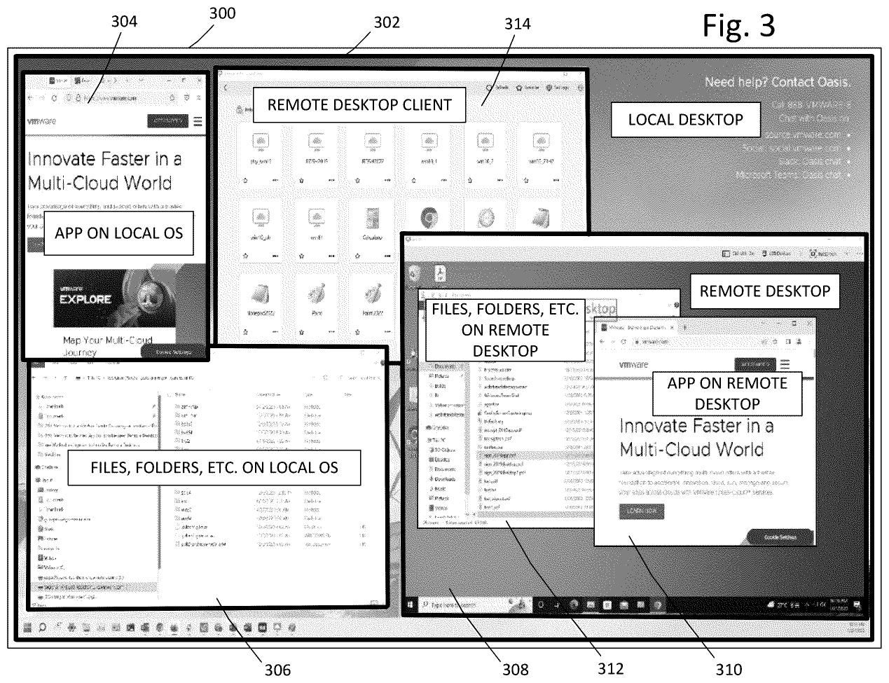

FIG. 3 is a diagram illustrating an example of local desktop windows and remote desktop windows being presented on a display screen. Specifically, the user has logged into a remote desktop session and is viewing a display screen 300 of a laptop or other local client device. The display screen 300 renders a local desktop 302.

A window 304 of a local application, which is supported by a local operating system (OS) and which has been launched, may be displayed on the local desktop 302. A window 306, which identifies the local files, drives/folders, directory, etc. provided/supported by the local OS, may also be concurrently or separately displayed on the local desktop 302.

In the example of FIG. 3, wherein the user has logged into a remote desktop session, the display screen 300 is rendering a remote desktop 308 as a remote display. The remote desktop 308 may occupy the entire real estate of the display screen 300 (such as by covering the entire local desktop 302), or may occupy less than the entire real estate of the display screen 300, such that other windows on the local desktop 302 may be concurrently displayed with the remote desktop 308. The remote desktop 308 may in turn display one or more windows, such as a window 310 of a remote application, and a window 312 that identifies the remote files, folders, directory, etc. provided/supported by the remote OS installed on the remote desktop 308.

The display screen 300 may also display a window 314 or other UI of a remote desktop client installed on the user's local client device, separately or concurrently with other windows. An example of the remote desktop client is the Horizon client of VMware, Inc. of Palo Alto, California or other analogous client capable to establish and support a remote desktop session. The window 314 of the remote desktop client may display, for example, a plurality of icons that each represent a remote desktop entitled to be used by the user, a plurality of icons of remote applications available via the remote desktop 308, etc.

FIG. 3 depicts an example wherein the user may need to work with remote files/applications and local files/applications at the same time, which is a common use scenario. At least the following conditions may make it difficult to effectively and efficiently use local and remote files/applications concurrently:

1. Users have to deal with two (local and remote) types of OSs, two types of applications, and two types of folders and files. The user experience may be bad especially when the local OS is different from the remote OS, since different OSs have different behaviors and operations. For example, the local OS may be MacOS of Apple Inc. and the remote may be Windows of Microsoft Corporation.
2. Many steps may be needed in order to start remotely working. For example, the user may need to first launch the remote desktop client, log into a connection server to obtain the entitled remote desktops, and then connect to the remote desktop(s) and open a file browser (e.g., File Explorer) to find the target remote files.
3. More steps and configurations may need to be performed if the user wants to use a local application to load/open a remote file, or use a remote application to open a local file. The user may also want to use a remote application to edit a remote file that is located on another remote desktop, which can be a difficult task/feature to enable.
4. The installer file of a remote desktop client (e.g., a Horizon client) can become undesirably larger and larger as the installer file tries to visualize/enable more features.

### Localizing a Remote Desktop

To address the above and other drawbacks, the embodiments disclosed herein provide solutions/techniques to use remote applications and remote files on a local OS, without having to use a remote desktop client to render a user interface (UI). With these techniques, the remote desktop client runs in a background as one or more services without any UI. A user may access and use remote applications/files via the same UIs that are used to access and use local applications/files, thereby avoiding having to require the user to manage separate (e.g., two) types of OSs, applications, and files and folders. Such solution also avoids excessive steps/configurations associated with concurrent use of local/remote applications/files, and further avoids placing any additional burden on installer files.

According to various embodiments, remote desktops and corresponding remote drives/folders, remote files etc. that reside on the remote desktops are thus localized with respect to the local OS. Localization (and other similar terminology used herein) according to various embodiments may refer to a remote component (e.g., remote desktops, drives, folders, files, or other remote desktop components installed on the remote desktops) being mapped to or otherwise associated with a local OS, so as to give a user the perception that such localized remote desktop components reside on the local desktop and are usable through or otherwise supported by the local OS, when in reality such remote components reside at the remote desktops.

To initialize this solution, the user may first log into a connection server, such as by using a web browser (instead of a remote desktop client), and configure one or more of the following, as examples:
1. Selection of remote applications on remote desktops that are desired to be used as local applications.
2. Selection of drives or folders on remote desktops that are desired to be used as local drives or folders.
3. Selection of which remote desktops are desired to be used to open local files.

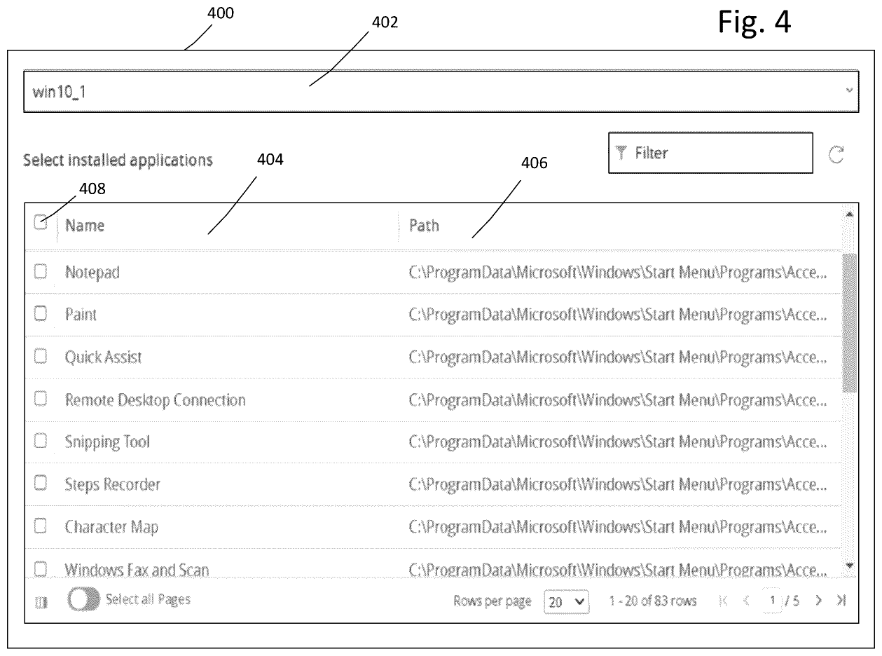

FIG. 4 shows an example user interface window 400 that may be used to select remote applications for localization. The window 400 may be, for example, a browser-based window that is rendered on the display screen 300, after the web browser on the local client device has logged into the connection server. The connection server may in turn collect/compile the information shown in the window 400, for display by the web browser.

In the example of FIG. 4, the window 400 includes a field 402 that identifies a particular remote desktop (e.g., win10_1) selected by the user. The window 400 displays a list of remote applications (installed on that remote desktop), by name 404 and path 406 of the remote application in the directory structure of the remote desktop. In some embodiments, the path 406 may specify the path on the local OS (local desktop) where the selected remote application may be localized. Each corresponding remote application includes a selection box 408, which if selected by the user, selects the remote application for localization.

After the selection/configuration using the window 400 has been completed, the remote desktop client (running as one or more background services) may be requested to perform at least three tasks based on the configuration performed by the user via the window 400.

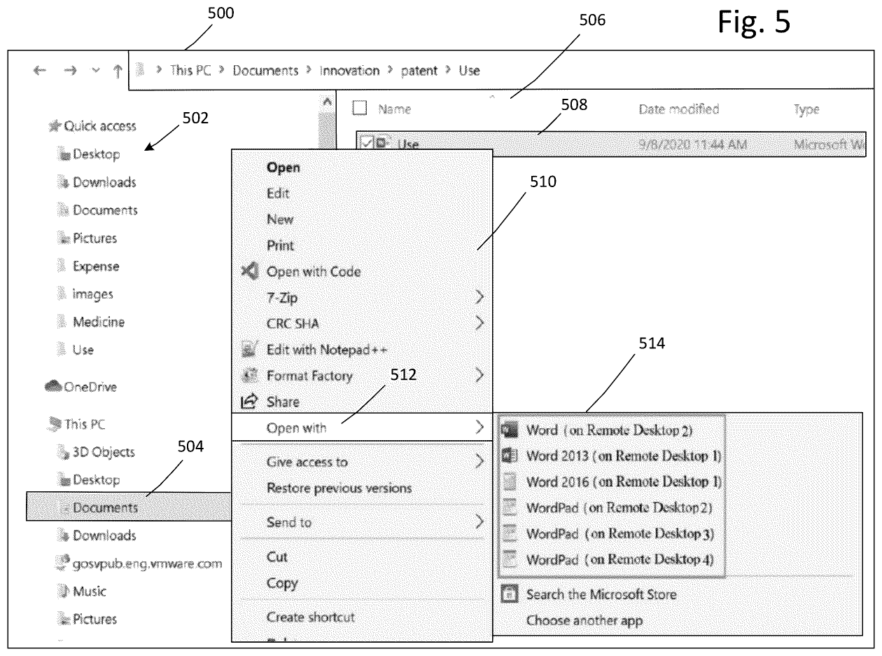

As a first task, the remote desktop client may register the selected remote applications to the local OS and associates file extensions to these remote applications, so that the user can use these remote applications (just like using local applications) to open local files. For instance, FIG. 5 shows an example user interface window 500 that may be provided by the local OS to enable a localized remote application to open a local file.

The window 500 may display a directory 502 listing local folders (or other local content that resides on the user device 146), of which the Documents folder 504 is selected. A sub-window 506 shows a local file 508 that is stored in the folder 504.

If a particular remote application is set as a default application for opening the type of file of the local file 508, then the local file 508 may be opened (by the particular remote application) by double clicking on the local file 508 in the sub-window 506. As an alternative, the user may right click on the local file 508 in the sub-window 506, which in turn causes a menu 510 to be launched and displayed in the window 500. The user can navigate to an Open with option 512 on the menu 510, which in turn causes a sub-menu 514 to be displayed. The sub-menu 514 provides a list of remote applications (installed on one or more remote desktops and which have been localized to the local OS). The user may select (e.g., click on) one of the listed remote applications in the sub-menu 514, which will then thereby cause the selected remote application to open the local file 508. According to various embodiments, the local file 508 is then opened/rendered on a remote desktop on which the selected remote application is installed (e.g., the remote desktop 308).

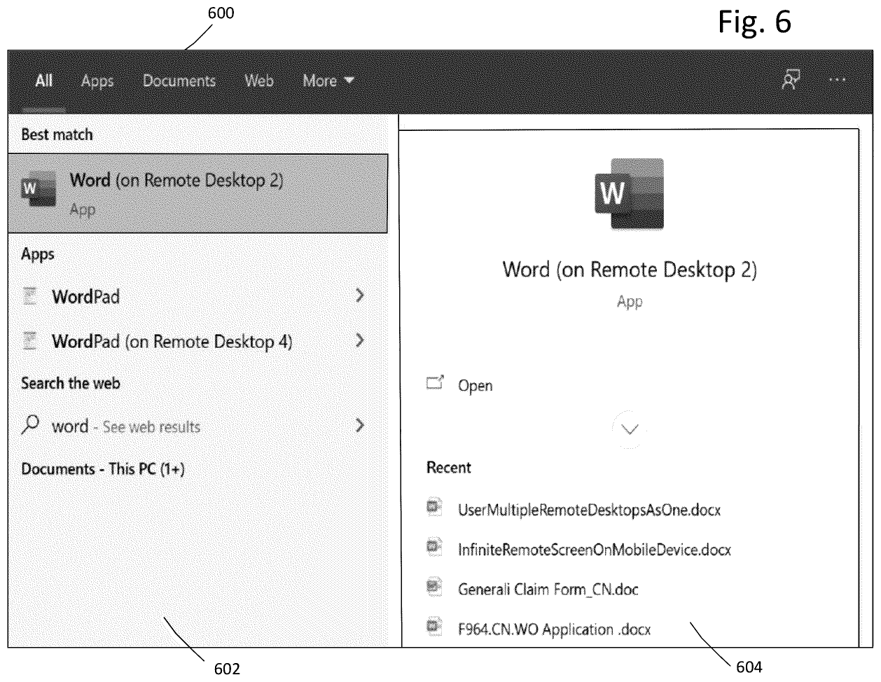

Additionally, a file explorer tool or other file browser on the local OS may be used to search for remote applications (which have been selected for localization), as well as searching for local applications. FIG. 6 shows an example user interface window 600 that may be provided by a local OS to enable searching for a remote application that has been localized.

In the example of FIG. 6, the user has performed a keyword (e.g., application name) search for a particular remote application that has been localized. A sub-window 602 displays a hitlist of both local and remote applications that match the keyword(s) in the search. A sub-window 604 enables the user to open a remote application identified in the hitlist of the sub-window 602 as being a best match for the keyword search, and may also display a list of recent local and/or remote files that may be selected for opening by the localized remote application in the hitlist.

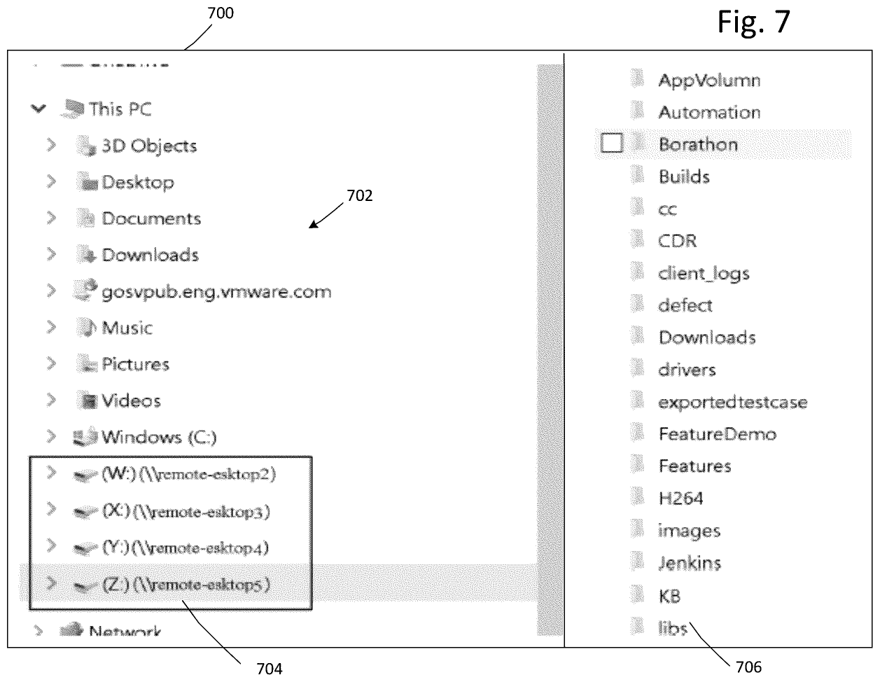

As a second task, the remote desktop client may register and map (e.g., redirect) the remote drives or folders on remote desktops to the local OS, so that the user can access these redirected drives/folders as local drives/folders. FIG. 7 shows an example user interface window 700 that may be provided by the local OS to display remote drives/folders as local drives/folders.

In the example of FIG. 7, the window 700 displays a directory 702 of local drives/folders of This PC, with the remote drives/folders 704 (which have been localized) of one or more remote desktops being included amongst the drives/folders of in the directory 702. A sub-window 706 may display the remote folders/files of a particular remote drive/folder listed in the directory 702, and which may be selected for accessing/opening.

Furthermore, a feature associated with the window 700 (or some other windows analogous to the windows 500, 600, 700) enables a user to open a remote file on a (first) remote desktop A using remote application on a (second) remote desktop B. The user can also launch a remote file on other remote desktops. For instance, remote applications, remote drives/folders, and remote files of multiple remote desktops can be localized on the local OS, such as in the various examples previously described above, such that the user can select any of these localized remote applications, drives/folders, and files from the local OS (e.g., UIs provided by the local OS) for launching/opening.

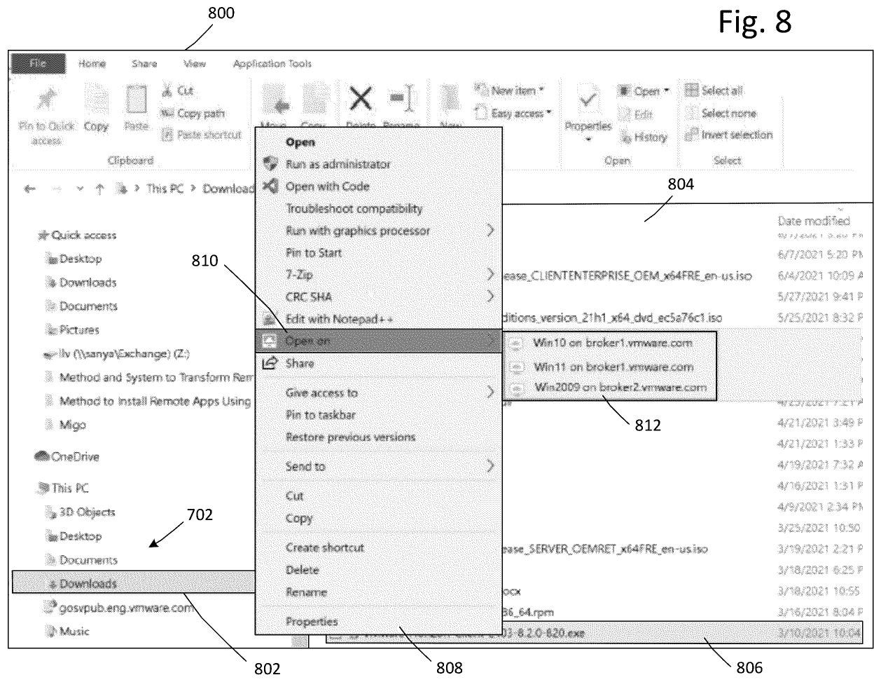

As a third task, the remote desktop client may register selected remote desktops to the local OS so that the user can open a local file on a specified one of these remote desktops that have been localized. For instance, FIG. 8 shows an example user interface window 800 that may be provided by a local OS to enable selection of a localized remote desktop on which a local file can be opened.

In the example of FIG. 8, the window 800 displays the directory 702 that lists local folders/files, including a Downloads folder 802. A sub-window 804 displays the local files that are contained in the folder 802, including a local file 806 that has been selected. A menu 808 provides an Open on option 810, which enables the user to select from a list 812 of localized remote desktops on which to open the local file 806.

With this feature depicted by way of example in FIG. 8, the user can run any type of file on a selected remote desktop that has been localized. For example, if the user wants to open a local word processing file (e.g., a .doc file) on the selected remote desktop in the manner depicted in FIG. 8, the .doc file is first redirected to the selected remote desktop and then opened on the remote desktop using a default or other compatible remote application installed on that remote desktop. In some embodiments, the entirety of the selected remote desktop is not displayed on the display screen (e.g., the display screen 300)—instead, the graphics and other content of the remote desktop may be cropped so as to just display the window of the remote application that has opened and is presenting the local file (e.g., the .doc file). This presentation provides an illusion to the user that a local application is being used on the local desktop for that local file.

In some embodiments, if the user wishes to run a local executable file (e.g., an .exe file or other executable file type) on the selected remote desktop, the executable file may be run directly run on the selected remote desktop. Furthermore in some embodiments, the user can install an application on a remote desktop using a local installer file without connecting to the remote desktop.

Hence, with the techniques described above with respect to the examples of FIGS. 3-8, remote desktops (including their remote desktop components, such as remote applications, remote drives/folders, etc.) can be localized to a local desktop, so that a user can perform their remote work without launching a UI of a remote desktop client (e.g., a Horizon client UI) that connects to a remote desktop. With such techniques, when users are working on remote desktops, the users have a perception that they are using a local OS. The disclosed embodiments not only advantageously break/blur the boundary between a local desktop and a remote desktop, but also the boundary between multiple remote desktops.

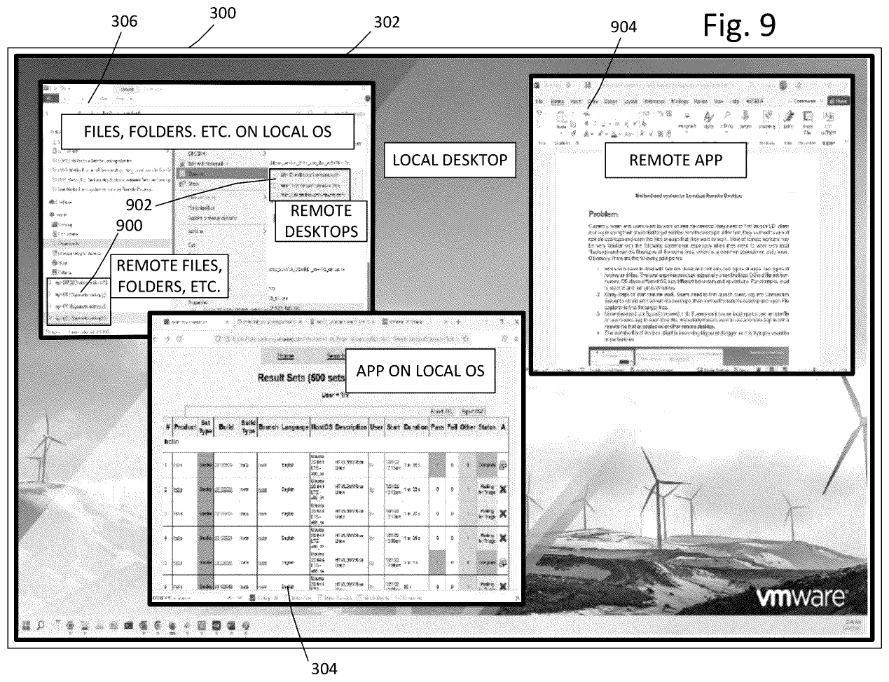

For instance, FIG. 9 is a diagram illustrating an example of a local desktop (e.g., the local desktop 302) having a localized remote application rendered on a display screen (e.g., the display screen 300), with a simplified working environment that is advantageously provided by the embodiments disclosed herein. In the example of FIG. 9, the local desktop 302 presents the window 304 having a local application rendered therein. The local desktop 302 further presents the window 306 (of the local OS) that identifies the local files, drives/folders, etc. installed on the local desktop 302, and that also identifies the remote drives/folders (at 900) and the remote desktops (at 902), etc. that have been localized in the manner described above with respect to FIGS. 3-8.

A window 904 of a localized remote application may also be presented on the local desktop 300, with the graphics and other content of the corresponding localized remote desktop (which has opened the remote application) being cropped out. The file being rendered by the localized remote application in the window 904 may be a local file residing on the local desktop 302, or may be a remote file residing on the remote desktop 308 or on some other localized remote desktop.

To assist in further explaining the details of how remote desktops (including their corresponding remote desktop components, such as remote applications, remote drives/folders, remote files, etc.) may be localized, a description is provided next below regarding a computing environment and client and agent components that may be provided to support such localization.

### Computing Environment

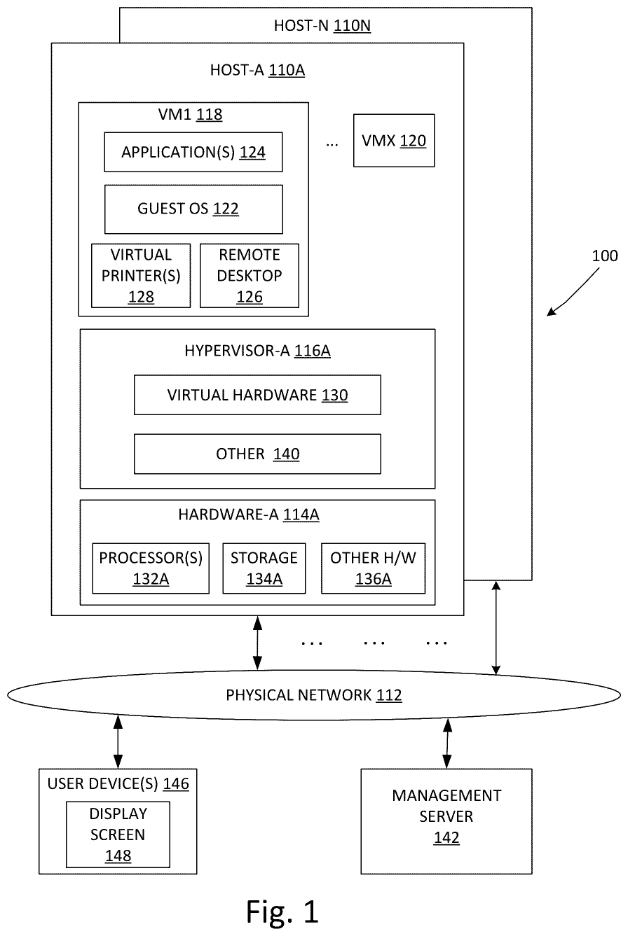

FIG. 1 is a schematic diagram illustrating an example virtualized computing environment 100 that can implement a virtual desktop infrastructure (VDI) having capability to enable the localization of a remote desktop. Depending on the desired implementation, virtualized computing environment 100 may include additional and/or alternative components than that shown in FIG. 1.

In the example in FIG. 1, the virtualized computing environment 100 includes multiple hosts, such as host-A 110A . . . host-N 110N that may be inter-connected via a physical network 112, such as represented in FIG. 1 by interconnecting arrows between the physical network 112 and host-A 110A . . . host-N 110N. Examples of the physical network 112 can include a wired network, a wireless network, the Internet, or other network types and also combinations of different networks and network types. For simplicity of explanation, the various components and features of the hosts will be described hereinafter in the context of the host-A 110A. Each of the other host-N 110N can include substantially similar elements and features.

The host-A 110A includes suitable hardware 114A and virtualization software (e.g., a hypervisor-A 116A) to support various virtual machines (VMs). For example, the host-A 110A supports VM1 118. . . . VMX 120, wherein X (as well as N) is an integer greater than or equal to 1. In practice, the virtualized computing environment 100 may include any number of hosts (also known as computing devices, host computers, host devices, physical servers, server systems, physical machines, etc.), wherein each host may be supporting tens or hundreds of virtual machines. For the sake of simplicity, the details of only the single VM1 118 are shown and described herein.

VM1 118 may be an agent-side VM that includes a guest operating system (OS) 122 and one or more guest applications 124 (e.g., remote applications and their corresponding processes) that run on top of the guest OS 122. Using the guest OS 122 and/or other resources of VM1 118 and the host-A 110A, VM1 118 may generate one or more remote desktops 126 (e.g., the remote desktop 308 or other virtual desktops) that is operated by and accessible to one or more client-side user device(s) 146 (e.g., a local client device) via the physical network 112. One or more virtual printers 128 also may be instantiated in VM1 118 and/or elsewhere in the host-A 110A, and may correspond to one or more physical printers (not shown) connected to the user device 146 at the client side. VM1 118 may include other elements, such as code and related data (including data structures), engines, etc., which will not be explained herein in further detail, for the sake of brevity.

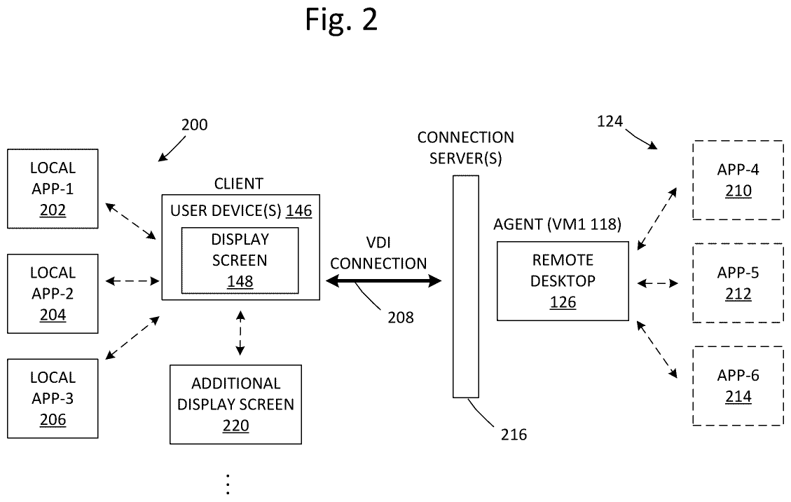

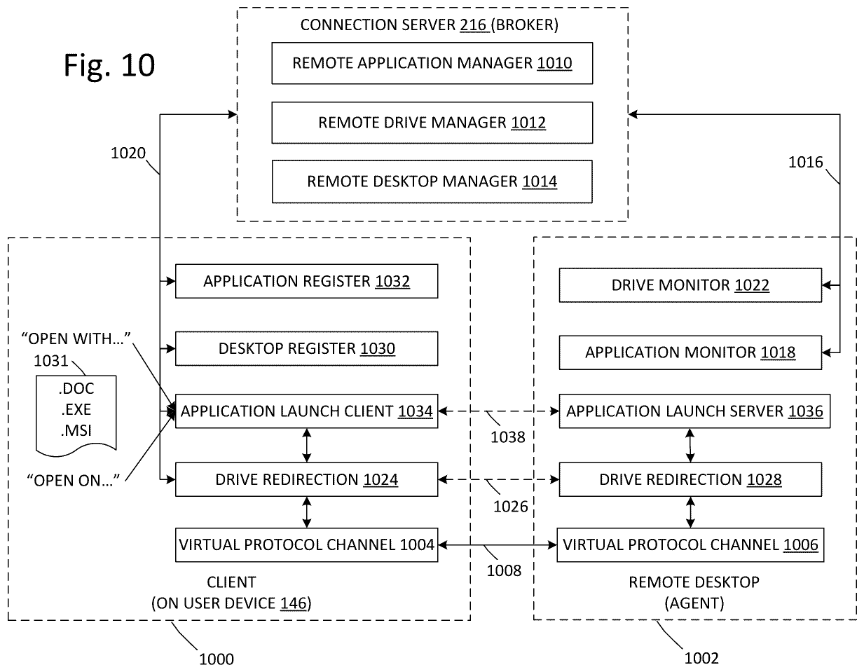

The user device 146 may include a display screen 148 and other components (explained in more detail in FIGS. 2 and 10) to support the use of the user device 146 in cooperation with the virtual desktop 126 and other elements of VM1 118. The display screen 148 or some other display screen may be the display screen 300 that may render the various windows/UIs and other content shown by way of example in FIGS. 3-9.

According to various embodiments, VM1 118 may operate as an agent that provides the remote desktop 126 (and other remote desktop features) to one or more of the user device 146. For instance, the agent can cooperate with client software (referred to at times herein as a remote desktop application, client application, remote desktop client, or client, installed at the user device 146) to establish and maintain a remote desktop connection between VM1 118 and the user device 146 for purposes of enabling the user to operate the user device 146 in order to access and use the remote desktop 126, including when the client software operates in the background as one or more services as described herein in the context of localization. In some embodiments, the agent can be a sub-component of VM1 118. Examples of the agent and client software are the Horizon agent and the Horizon client, respectively, of VMware, Inc. of Palo Alto, California.

One or more connection servers 216 (shown in FIG. 2) can broker or otherwise manage communications between the agent (e.g., a Horizon agent or other analogous remote desktop agent) and the client software (e.g., a Horizon client or other analogous remote desktop client) over a VDI connection 208 (also shown in FIG. 2) provided by the physical network 112. A management server 142 and/or other server(s)/device(s) can operate as the connection server in some implementations.

The hypervisor-A 116A may be a software layer or component that supports the execution of multiple virtualized computing instances. The hypervisor-A 116A may run on top of a host operating system (not shown) of the host-A 110A or may run directly on hardware 114A. The hypervisor 116A maintains a mapping between underlying hardware 114A and virtual resources (depicted as virtual hardware 130) allocated to VM1 118 and the other VMs. The hypervisor-A 116A may include other elements (shown generally at 140), including tools to provide resources for and to otherwise support the operation of the VMs.

Hardware 114A in turn includes suitable physical components, such as central processing unit(s) (CPU(s)) or processor(s) 132A; storage device(s) 134A; and other hardware 136A such as physical network interface controllers (NICs), storage disk(s) accessible via storage controller(s), etc. Virtual resources (e.g., the virtual hardware 130) are allocated to each virtual machine to support a guest operating system (OS) and remote application(s) in the virtual machine, such as the guest OS 122 and the guest application(s) 124 (e.g., a word processing application, accounting software, a browser, etc.) in VM1 118. Corresponding to the hardware 114A, the virtual hardware 130 may include a virtual CPU, a virtual memory, a virtual disk, a virtual network interface controller (VNIC), etc.

The management server 142 of one embodiment can take the form of a physical computer with functionality to manage or otherwise control the operation of host-A 110A . . . host-N 110N. In some embodiments, the functionality of the management server 142 can be implemented in a virtual appliance, for example in the form of a single-purpose VM that may be run on one of the hosts in a cluster or on a host that is not in the cluster.

The management server 142 may be communicatively coupled to host-A 110A . . . host-N 110N (and hence communicatively coupled to the virtual machines, hypervisors, hardware, etc.) via the physical network 112. In some embodiments, the functionality of the management server 142 may be implemented in any of host-A 110A . . . host-N 110N, instead of being provided as a separate standalone device such as depicted in FIG. 1.

Depending on various implementations, one or more of the physical network 112, the management server 142, and the user device(s) 146 can comprise parts of the virtualized computing environment 100, or one or more of these elements can be external to the virtualized computing environment 100 and configured to be communicatively coupled to the virtualized computing environment 100.

FIG. 2 is a schematic diagram illustrating client and agent devices for the virtualized computing environment 100 of FIG. 1. More specifically, FIG. 2 shows a client (e.g., a Horizon client or other analogous remote desktop client running on the user device 146) and an agent (e.g., the VM1 118 and/or a component thereof, such as a Horizon agent or other analogous remote desktop agent, that provides the remote desktop 126 and which runs on a host).

At a client side 200, the user device 146 may have local applications (APPs) installed on it. These applications may include a local APP-1 202, a local APP-2 204, a local APP-3 206, etc. These local applications (e.g., their respective icons or launched files/interfaces) may in turn be presented on a local desktop rendered on the display screen 148 of the user device 146, such as the local desktop 302 rendered on the display screen 300. Examples of these local applications may include but not be limited to Slack, Microsoft Teams, Microsoft Outlook, and/or other types of messaging/collaboration applications, as well as other locally installed applications such as a calendar application, word processing application, spreadsheet application, games, browser, etc.

One or more additional display screens 220, which can be the display screen 300, may be connected to the user device 146. A remote desktop (localized and non-localized) and their corresponding applications (localized and non-localized) may be displayed on either or both of the display screens 148 and 220, concurrently with or without local applications/content of a local desktop also being displayed on the display screen(s) 148 and 220. The user may select one of the display screens 148 and 220 to be a primary display screen, and may select the other display screen to be a secondary display screen. Various display configurations and capabilities may be provided.

The remote desktop client installed at the user device 146 may use one or more VDI connections 208 to establish and conduct a remote desktop session with the VDI at an agent side. One or more connection servers 216 at the agent side may manage these connections to the remote desktops 126 (e.g., for brokering communications, load balancing purposes, etc.).

At the agent side, the remote desktop 126 may provide remote applications installed/running thereon (e.g., the guest applications 124 of FIG. 1). These remote applications on the remote desktop 126 may include an APP-4 210, an APP-5 212, an APP-6 214, etc. In some embodiments, one or more of the APP-4 210, an APP-5 212, an APP-6 214, etc. may be a browser, multimedia player, online meeting platform, communication application, electronic game, or other type of application or tool that can be localized in the manner previously described above.

### Client and Agent for Supporting Localization of Remote Desktops

FIG. 10 is a schematic diagram illustrating modules of a client and an agent that cooperate to enable the localization of a remote desktop. More specifically, FIG. 10 shows example modules of a remote desktop client 1000 (e.g., a Horizon client or other analogous remote desktop client), a remote desktop agent 1002 (e.g., a Horizon agent or other analogous remote desktop agent), and other components/devices of FIG. 2 that may support the capability to localize a remote desktop (including its remote desktop components), such as depicted in FIGS. 4-9 above. Various modules or other components of the client, agent, etc. of FIG. 10 may be embodied as software or other computer-readable instructions stored on computer-readable media and executable by one or more processors, may be embodied in hardware, and/or may be embodied as a combination of hardware and software.

The client 1000 may reside on the user device 146 at the client side. The agent 1002 resides on a host at the agent side and is configured to provide one or more remote desktops 126 (e.g., the remote desktop 308 and its remote desktop components, which may be localized) and related functionality to the client 1000. The connection server 216 operates to broker communications between the agent 1002 and the client 1000.

For example, the connection server 216 may be configured to help establish a connection between the client 1000 and the agent 1002 (the remote desktop 126) by requesting a session token from the remote desktop 126 and then returning the session token to the client 1000. The client 1000 will then contact the remote desktop 126 using the session token so as to establish a connection (e.g., the VDI connection 208) and a virtual channel (e.g., a virtual protocol channel 1004 and a virtual protocol channel 1006) for transferring (via 1008) data between the user device 146 at the client side and the remote desktop 126 at the agent side. The connection server 216 may comprise, among other things, a plurality of modules or other components, including a remote application manager 1010, a remote drive manager 1012, and a remote desktop manager 1014.

The remote application manager 1010 of various embodiments may be configured to enable the user to specify which remote applications on which remote desktops are to be registered to the local OS, so that the user can use these remote applications on the local OS like local applications. During the user's configuration and when the user selects a remote desktop for localization, the remote application manager 1010 requests (via 1016) a remote application monitor module 1018 on that remote desktop to collect the information for installed remote applications, so that the remote application manager 1010 can dynamically display the installed remote applications to the user, such as in the example of FIG. 4. Once the user completes the configuration/selection of remote applications for localization, the information of the selected remote application(s) is sent (via 1020) to the client 1000, so that these remote applications can be registered to the local OS. The information of the remote applications may include, for example, the remote application name, remote application icon, file extensions associated with the remote applications, the remote application path (on the remote desktop 126), the remote application location (e.g., on which remote desktop the remote application is installed), etc.

The remote application manager 1010 may then inform (via 1016) the remote application monitor module 1018 on the remote desktop to monitor for changes to these remote applications. For example, if any selected remote application is uninstalled, upgraded, or moved to another location, the remote application monitor module 1018 on the remote desktop will inform (via 1016) the remote application manager 1010, which will then update the remote application information maintained on the connection server 216 and will request (via 1020) the client 1000 to make an appropriate update to the localized remote application that is registered on the local OS.

The remote drive manager 1012 of various embodiments may be configured to enable the user to specify which remote folders/drives on remote desktops are to be redirected to the local OS, so that the user can access these remote folders/drives in a manner analogous to accessing local folders/drives. During the user's configuration and once the user has specified a remote desktop, the remote drive manager 1012 will communicate (via 1016) with a remote drive monitor module 1022 on that remote desktop to dynamically retrieve and display the remote folders/drives information, for presentation to the user. Once the user completes the folder/drive configuration (e.g., selects remote folders or drives for localization), the selected remote folders/drives information is sent (via 1020) to a drive redirection module 1024 on the client 1000, and the drive redirection module 1024 will then work with (via 1026) a counterpart drive redirection module 1028 on the corresponding remote desktop to redirect the selected remote folders/drives (including files) to the local OS. The remote folders/drives information may include, for example the name of the remote folders/drives, a path, a location, etc.

Furthermore, the remote drive manager 1012 will inform (via 1016) the drive monitor module 1022 on the corresponding remote desktop to monitor for any changes to these remote folders and drives. If any changes are detected, such as a remote folder/drive being removed, renamed, moved, etc., the drive monitor module 1022 on the remote desktop will inform (via 1016) the remote drive manager 1012, which will then update the remote folder/drive information maintained on the connection server and will also inform (via 1020) the drive redirection module 1024 on the client 1000 to update the redirected folders/drives accordingly.

The remote desktop manager 1014 of various embodiments may be configured to enable a system administrator to manage remote desktops for all users. Furthermore and with respect to localization, the remote desktop manager 1014 may be configured to enable the user to specify which remote desktops are to be registered to the local OS (e.g., localized), so that the user can run a local file on any registered remote desktop, such as by right clicking on the local file 806 and selecting a remote desktop using the menu 808 and the Open on . . . ” option 810 depicted in FIG. 8.

Once the user completes the above configuration, the information of selected remote desktops is sent (via 1020) to the client 1000, so as to register the selected remote desktops to the local OS. If the remote desktops undergo some changes, such as being renamed, being reset by the system administrator as unentitled to the user, etc. the remote desktop manager 1014 will request (via 1020) a desktop register module 1030 on the client 1000 to update the remote desktop registration accordingly.

With respect to the modules of the client 1000, an application register module 1032 of various embodiments may be configured to work with the remote application manager 1010 on the connection server 216 to obtain (via 1020) the information of user-selected remote applications for localization, and to then create/update file associations on the local OS, so that when the user double clicks to open a file 1031 (or right clicks on the file 1031 and selects the Open with option 512 on the menu 510 on the local OS, such as depicted in FIG. 5), the user can select an appropriate localized remote application of the remote desktop to open the file 1031.

To associate remote applications on remote desktops with the files on the local OS, an application launch client module 1034 may be registered as a file handler, such as by adding a program identifier in HKEY_CURRENT_USER/Software/Classes with the proper application information (e.g., remote application name, target remote desktop, etc.) so that the application launch client module 1034 can be called to handle a request to open the file 1031 with the localized remote application.

Furthermore, the application register module 1032 may also be responsible for creating/updating application information under the local OS's application search path, so that when the user searches the local OS for localized remote applications by application name, the matching remote applications can be returned as search results. When the user searches for and then clicks on a localized remote application, the application register module 1032 will then call the application launch client module 1034 to handle this request to launch that selected localized remote application.

The desktop register module 1030 of various embodiments may be configured to work with the remote desktop manager 1014 on the connection server 216 to register the user-selected remote desktops to the local OS, so that the user can right click on the file 1031 on the local OS and select a remote desktop to run this file 1031. For example and as depicted in FIG. 8, the menu 808 may provide an Open on option 810 to select a remote desktop to run the file 1031.

The desktop register module 1030 of various embodiments may be configured to register the application launch client module 1034 as a file handler with required remote desktop information, such as the fully qualified domain name (FQDN) and internet protocol (IP address) of the remote desktop, so that when the user clicks on a remote desktop from the list 812 of remote desktops, via the menu 808 and the Open on option 810, the application launch client module 1034 can handle this request appropriately. Also, if the remote desktop information is changed on the connection server 216, the connection server 216 will inform the desktop register module 1030 to update the registered remote desktop information on the client 1000.

The application launch client module 1034 of various embodiments may be configured to work with an application launch server module 1036 on the remote desktop to launch (at 1038) a remote application as a seamless window (e.g., a cropped window such as depicted in FIG. 9), with one or more of the following example conditions:
1. When the user right clicks on a local file and selects a localized remote application from the menu 510 and Open with option 512, the application launch client module 1034 first identifies the remote desktop where the selected remote application is installed, and then requests the drive redirection module 1024 to redirect this local file to the target remote desktop. After the local file is successfully redirected, the application launch client module 1034 communicates (at 1038) with the application launch server module 1036 on the target remote desktop, and requests the application launch server module 1036 to launch the selected remote application and load the redirected file.
2. When the user double clicks on a local file to open the file, and if the default application for this file is set to some localized remote application, the process of opening the remote application and loading file may be similar with the first condition described above.
3. When the user searches for some registered/localized remote applications on the local OS and then clicks to open the localized remote application, the application launch client module 1034 identifies the remote desktop where the selected remote application is installed and then works with the application launch server module 1036 on that remote desktop to launch the remote application as a seamless window.
4. When the user right clicks on a local file and selects a remote desktop from the list 812 of remote desktops, via the menu 808 and the Open on option 810, the process of launching the remote application and loading file may be similar to the first condition described above.
5. If the user tries to open a remote file within a redirected (localized) remote folder on the local OS, the application launch client module 1034 will first identify if the file is from the same remote desktop as the selected remote application. If yes, then file will not be redirected—the application launch client module 1034 will instead inform the application launch server module 1036 of the file's actual path on the remote desktop, so that the application launch server module 1036 can launch the remote application and load that remote file directly.

The drive redirection module 1024 of various embodiments may be configured to work with its counterpart drive redirection module 1028 on the remote desktop, so as to redirect the user-specified remote folder/drive to the local OS. Also, when the user tries to use a remote application to open a local file, the drive redirection module 1024 will work with its counterpart drive redirection module 1028 on the remote desktop to redirect the local file to corresponding remote desktop where the selected remote application is installed, so that the remote application is able to access and load the local file.

The virtual protocol channel 1004 of various embodiments may be configured for the transfer of data, instructions, files, folders, or other content between the user device 146 and the remote desktop. With respect to the various localization capabilities and features described herein, the virtual protocol channel 1004 may be configured to transfer messages, data, instructions, etc. (including redirection instructions and content) between the client side and the remote desktop.

With respect now to the modules of the agent 1002, the drive monitor module 1022 of various embodiments may be configured to perform the following example tasks:
1. Monitor a redirected remote folder/drive and inform the connection server 216 of any changes (such as the remote folder/drive being renamed, moved, removed, etc.) in the remote folder/drive. The connection server 216 can then update the drive/folder information that is being maintained by the connection server 216.
2. When the end user configures a remote folder/drive on the connection server 216 for localization/redirection, the connection server 216 will request the drive monitor module 1022 to collect drive and folder information on the remote desktop and return that information to the connection server 216, so that the connection server 216 can display the folder/drive for the user to select.

The application monitor module 1018 of various embodiments may be configured to perform the following example tasks:
1. Monitor the user-selected remote applications on the remote desktop and inform the connection server 2016 of any changes to these remote applications. The connection server 216 will then update the selected application information maintained by the connection server 216.
2. When the end user configures remote applications on the connection server 216, the connection server 216 will request the application monitor module 1018 to collect the remote application information on the selected remote desktop and return such information to the connection server 216, so that the connection server 216 can display the remote applications for the user to select for localization.

The application launch server module 1036 of various embodiments may be configured to work with the application launch client module 1034 on the client 1000 to launch a requested remote application on the remote desktop and to load files. The application launch server module 1036 displays the remote application's window as a seamless window, so that the user can use the remote application in a manner similar to a local application.

The drive redirection module 1028 of various embodiments may be configured to work with its counterpart drive redirection module 1024 on the client 1000 to redirect the user-specified remote folder/drive to the local OS. Also, when the user tries to use a remote application to open a local file, the drive redirection module 1028 will work with its counterpart drive redirection module 1024 on the client 1000 to redirect the local file to the corresponding remote desktop where the selected remote application is installed, so that the remote application is able to access/open the local file.

The virtual protocol channel 1006 of various embodiments may be configured to work with its counterpart virtual protocol channel 1004 on the client 1000 to transfer data, files, folders, mapping/redirection information, commands/instructions, etc. between the client side and the remote desktop.

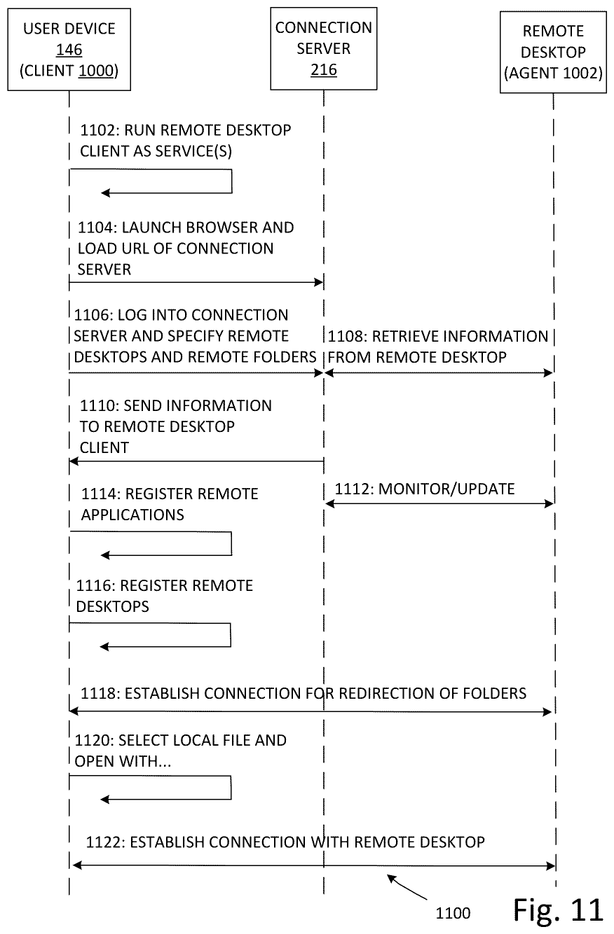

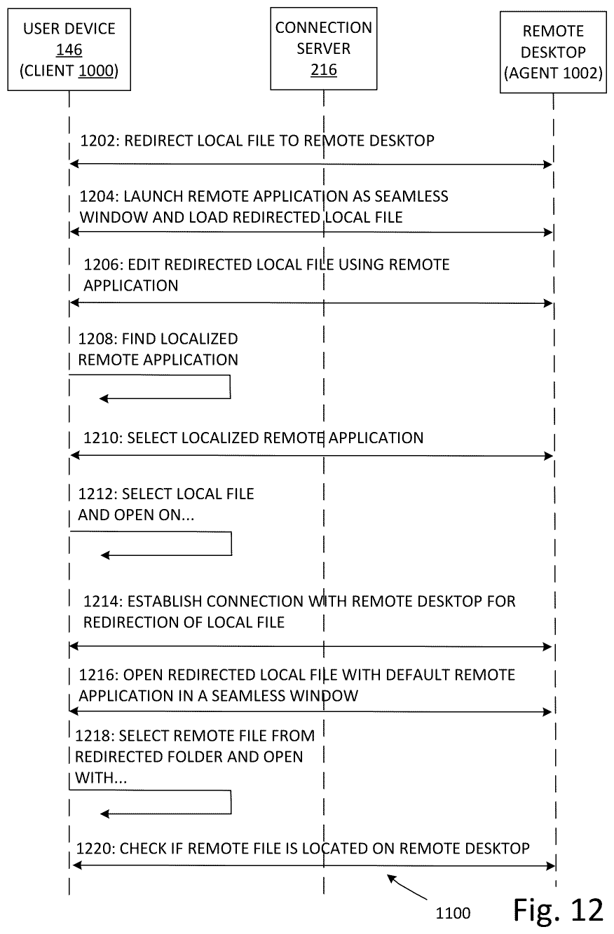

FIGS. 11 and 12 are flow diagrams of an example method 1100 to localize a remote desktop at a client side. More specifically, the method 1100 may be performed to enable a remote desktop (including its remote desktop components such as remote applications, remote files, remote drives/folders, etc.) to be mapped to a local OS, so that a user can use the remote desktop as if using a local application, such as depicted in the examples of FIGS. 4-10.

The example method 1100 may include one or more operations, functions, or actions illustrated at 1102 to 1220, in which the operations of FIG. 11 continue into FIGS. 12. The various operations of the method 1100 and/or of any other process(es) described herein may be combined into fewer operations, divided into additional operations, supplemented with further operations, and/or eliminated based upon the desired implementation. In one embodiment, the operations of the method 1100 and/or of any other process(es) described herein may be performed in a pipelined sequential manner. In other embodiments, some operations may be performed out-of-order, in parallel, etc. The operations in the method 1100 are described below with reference to the various components shown in FIGS. 1-10.

According to one embodiment, the method 1100 may be performed by the client 1000, in cooperation with at least one agent (e.g., the agent 1002) and the connection server 216 for some operations. In other embodiments, various other elements in a computing environment may perform, individually or cooperatively, the various operations of the method 1100.

At 1102 (“RUN REMOTE DESKTOP CLIENT AS SERVICE(S)”), the remote desktop client is installed and run at the user device 146 as one or more background services. In this mode of operation as one or more services, the UI(s) of the remote desktop client are not displayed.

At 1104 (“LAUNCH BROWSER AND LOAD URL OF CONNECTION SERVER”), the user launches a web browser on the user device 146 and loads an address, such as a uniform resource locator (URL) address, of the connection server 216.

At 1106 (“LOG INTO CONNECTION SERVER AND SPECIFY REMOTE DESKTOPS AND REMOTE FOLDERS”), the user operates the web browser to log into the connection server 216. Once logged in, the user specifies the remote applications and remote desktops to be registered to the local OS, for localization. The user may also specify the remote folders/drives to be redirected to the local OS.

At 1108 (“RETRIEVE INFORMATION FROM REMOTE DESKTOP”), the connection server 216 communicates with the remote desktop to retrieve the information of the remote desktop and its remote applications and folders/drives etc., so that such information can be displayed by the connection server 216 for user selection.

At 1110 (“SEND INFORMATION TO REMOTE DESKTOP CLIENT”), the connection server 216 sends, to the remote desktop client, the information of the remote desktop, remote applications, remote files/folders, etc. Meanwhile at 1112 (“MONITOR/UPDATE”), the connection server 216 informs the remote desktop as to which remote applications, remote folders, etc. have been selected for localization by the user. The drive monitor module 1022 and the remote application monitor module 1018 on the remote desktop monitor the user-selected remote applications, remote folders, etc., and report changes in these remote applications and remote folders (e.g., remote application upgrades, relocation, uninstallation, etc., and remote folder relocation, renaming, removal, etc.) to the connection server 216. The connection server 216 can in turn update the remote application and remote folder information being maintained by the connection server, and inform the remote desktop client to update the registered remote applications and redirected folders accordingly.

At 1114 (“REGISTER REMOTE APPLICATIONS”), the remote desktop client registers the user-selected remote application(s) to the local OS, so that the user can operate the remote application to open a local file, such as by double clicking on the local file or via the Open with option 512 on the menu 510.

At 1116 (“REGISTER REMOTE DESKTOPS”), the remote desktop client registers the user-selected remote desktop(s) to the local OS, so that the user can open a local file on the remote desktop, such as by right clicking the local file and selecting a remote desktop from the list 812 of remote desktops via the menu 808 and Open on option 810.

At 1118 (“ESTABLISH CONNECTION FOR REDIRECTION OF FOLDERS”), the remote desktop client communicates with the remote desktop to establish a connection, so that the remote desktop can redirect the remote folders on the remote desktop to the local OS.

At 1120 (“SELECT LOCAL FILE AND OPEN WITH . . . ”), the user right clicks on a local file on the local OS and selects a remote application, via the menu 510 and Open with option 512.

At 1122 (“ESTABLISH CONNECTION WITH REMOTE DESKTOP”), the remote desktop client communicates with the remote desktop, where the selected remote application is installed, to establish a connection.

Continuing now to FIG. 12, at 1202 (“REDIRECT LOCAL FILE TO REMOTE DESKTOP”), the remote desktop client redirects the local file to the connected remote desktop.

At 1204 (“LAUNCH REMOTE APPLICATION AS SEAMLESS WINDOW AND LOAD REDIRECTED LOCAL FILE”), the remote desktop launches the selected remote application as/in a seamless window, and loads the redirected local file into the window. At 1206 (“EDIT REDIRECTED LOCAL FILE USING REMOTE APPLICATION”), the user edits the redirected local file using the remote application, and then saves the changes and closes the remote application.

At 1208 (“FIND LOCALIZED REMOTE APPLICATION”), the user can search for a localized remote application on the local OS, such as by inputting a keyword. The user may search for and find the localized remote application amongst the listed local applications, since the remote application has been registered to the local OS.

At 1210 (“SELECT LOCALIZED REMOTE APPLICATION”), the user may click on a localized remote application on the local OS, so as to select that localized remote application. The localized remote application may then be launched as a seamless window. At the backend, the remote desktop client first establishes a connection with the corresponding remote desktop, which will then launch that remote application and show a cropped/seamless remote application window, when the user launches the remote application that has been localized on the local OS.

At 1212 (“SELECT LOCAL FILE AND OPEN ON . . . ”), the user right clicks on a local file and selects to open the local file on a target remote desktop, via the Open on option 810 on the menu 808.

At 1214 (“ESTABLISH CONNECTION WITH REMOTE DESKTOP FOR REDIRECTION OF LOCAL FILE”), the remote desktop client establishes a connection with the target remote desktop and then redirects the selected local file to this remote desktop.

At 1216 (“OPEN REDIRECTED LOCAL FILE WITH DEFAULT REMOTE APPLICATION IN A SEAMLESS WINDOW”), the remote desktop opens the redirected local file using a default remote application for that file type, and displays the remote local application to the user as a seamless window.

At 1218 (“SELECT REMOTE FILE FROM REDIRECTED FOLDER AND OPEN WITH . . . ”), the user navigates to a redirected remote folder on the local OS and right clicks on a remote file in that remote folder, so as to select a localized remote application (via the Open with option 512 on the menu 510) to open the remote file.

At 1220 (“CHECK IF REMOTE FILE IS LOCATED ON REMOTE DESKTOP”), the remote desktop client checks if the remote file is located on the same remote desktop where the localized remote application is installed. If the remote file is located on the same remote desktop, then there is no need to redirect the remote file to a target remote desktop prior to establishing a connection with the target remote desktop—the target remote desktop can open the remote file directly using a remote application on that remote desktop.

From the embodiments disclosed herein, several benefits are realized. For example, users can use remote applications and remote files just like local applications and local files without having to launch a UI of a remote desktop client for connecting to a remote desktop. Also, users can run any type of file on a particular remote desktop even if the file is located on some other remote desktop.

Furthermore, the localization techniques disclosed herein advantageously blur the boundary between a local desktop and a remote desktop, local applications and remote applications, local files and remote files, and even the boundary between remote desktops.

Also, the user experience and efficiency of working remotely can be improved significantly. Moreover, the localization techniques help to reduce the usage of hardware resources on local devices and a cloud, since there is no need to launch a UI of a remote desktop client for connection to a remote desktop.

### Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIGS. 1-12. For example, computing devices capable of acting as agent-side host devices or client-side user devices may be deployed in or otherwise operate in conjunction with the virtualized computing environment 100.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances (VCIs) may include containers (e.g., running on top of a host operating system without the need for a hypervisor or separate operating system; or implemented as an operating system level virtualization), virtual private servers, client computers, etc. The virtual machines may also be complete computation environments, containing virtual equivalents of the hardware and system software components of a physical computing system.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other instructions to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

1. A method to localize remote desktops to a local operating system (OS) on a client device, the method comprising:
installing a remote desktop client on the client device to operate as at least one background service;
identifying a remote desktop component associated with a remote desktop to register with the local OS for localization;
receiving, by the remote desktop client from the remote desktop, information regarding the identified remote desktop component that enables registration of the remote desktop component with the local OS; and
presenting, by the local OS, a user interface (UI) that shows the registered remote desktop component as being local on the client device along with local content that resides on the local device.

2. The method of claim 1, wherein the remote desktop component includes one or more of: the remote desktop, a drive of the remote desktop, a folder of the remote desktop, a remote application installed on the remote desktop, or a remote file on the remote desktop.

3. The method of claim 1, wherein the registered remote desktop component presented on the UI includes a remote application, wherein the local content includes a local file, and wherein the method further comprises:
in response to selection of the local file for opening by the remote application presented on the UI, redirecting the local file to the remote desktop;
opening the local file on the remote desktop using the remote application; and
presenting the local file in a window of the remote application, wherein the window has content of the remote desktop cropped out.

4. The method of claim 1, wherein the registered remote desktop component presented on the UI includes the remote desktop, wherein the local content includes a local file, and wherein the method further comprises:
in response to selection of the local file for opening on the remote desktop presented on the UI, redirecting the local file to the remote desktop;
opening the local file on the remote desktop using a default remote application installed on the remote desktop; and
presenting the local file in a window of the default remote application, wherein the window has content of the remote desktop cropped out.

5. The method of claim 1, wherein the registered remote desktop component presented on the UI includes a remote folder, and wherein the method further comprises:
in response to selection of a remote file, in the remote folder presented on the UI, for opening, checking the remote desktop to determine if the remote file is located on the remote desktop;
in response to the remote file being located on the remote desktop, opening the remote file on the remote desktop using a remote application installed on the remote desktop; and
in response to the remote file being located on some other remote desktop, redirecting the remote file to the remote desktop and opening the remote file on using the remote application installed on the remote desktop.

6. The method of claim 1, further comprising:
performing a search on the local OS for local content, including a keyword search; and
presenting a hitlist that matches the search for local content, wherein the hitlist includes the registered remote desktop component.

7. The method of claim 1, further comprising:
monitoring the remote desktop for a change in the remote desktop component; and
in response to detection of the change, updating the registration of the remote desktop component with the local OS.

8. A non-transitory computer-readable medium having instructions stored thereon, which in response to execution by one or more processors, cause the one or more processors to perform a method to localize remote desktops to a local operating system (OS) on a client device, wherein the method comprises:
installing a remote desktop client on the client device to operate as at least one background service;
identifying a remote desktop component associated with a remote desktop to register with the local OS for localization;
receiving, by the remote desktop client from the remote desktop, information regarding the identified remote desktop component that enables registration of the remote desktop component with the local OS; and
presenting, by the local OS, a user interface (UI) that shows the registered remote desktop component as being local on the client device along with local content that resides on the local device.

9. The non-transitory computer-readable medium of claim 8, wherein the remote desktop component includes one or more of: the remote desktop, a drive of the remote desktop, a folder of the remote desktop, a remote application installed on the remote desktop, or a remote file on the remote desktop.

10. The non-transitory computer-readable medium of claim 8, wherein the registered remote desktop component presented on the UI includes a remote application, wherein the local content includes a local file, and wherein the method further comprises:
in response to selection of the local file for opening by the remote application presented on the UI, redirecting the local file to the remote desktop;
opening the local file on the remote desktop using the remote application; and
presenting the local file in a window of the remote application, wherein the window has content of the remote desktop cropped out.

11. The non-transitory computer-readable medium of claim 8, wherein the registered remote desktop component presented on the UI includes the remote desktop, wherein the local content includes a local file, and wherein the method further comprises:
in response to selection of the local file for opening on the remote desktop presented on the UI, redirecting the local file to the remote desktop;
opening the local file on the remote desktop using a default remote application installed on the remote desktop; and
presenting the local file in a window of the default remote application, wherein the window has content of the remote desktop cropped out.

12. The non-transitory computer-readable medium of claim 8, wherein the registered remote desktop component presented on the UI includes a remote folder, and wherein the method further comprises:
in response to selection of a remote file, in the remote folder presented on the UI, for opening, checking the remote desktop to determine if the remote file is located on the remote desktop;
in response to the remote file being located on the remote desktop, opening the remote file on the remote desktop using a remote application installed on the remote desktop; and
in response to the remote file being located on some other remote desktop, redirecting the remote file to the remote desktop and opening the remote file using the remote application installed on the remote desktop.

13. The non-transitory computer-readable medium of claim 8, wherein the method further comprises:
performing a search on the local OS for local content, including a keyword search; and
presenting a hitlist that matches the search for local content, wherein the hitlist includes the registered remote desktop component.

14. The non-transitory computer-readable medium of claim 8, wherein the method further comprises:
monitoring the remote desktop for a change in the remote desktop component; and
in response to detection of the change, updating the registration of the remote desktop component with the local OS.

15. A computing device, comprising:
a processor; and
a non-transitory computer-readable medium coupled to the processor and having instructions stored thereon, which in response to execution by the processor, cause the processor to perform operations to localize remote desktops to a local operating system (OS) on the computing device, wherein the operations comprise:
install a remote desktop client on the client device to operate as at least one background service;
identify a remote desktop component associated with a remote desktop to register with the local OS for localization;
receive, by the remote desktop client from the remote desktop, information regarding the identified remote desktop component that enables registration of the remote desktop component with the local OS; and
present, by the local OS, a user interface (UI) that shows the registered remote desktop component as being local on the computing device along with local content that resides on the local device.

16. The computing device of claim 15, wherein the remote desktop component includes one or more of: the remote desktop, a drive of the remote desktop, a folder of the remote desktop, a remote application installed on the remote desktop, or a remote file on the remote desktop.

17. The computing device of claim 15, wherein the registered remote desktop component presented on the UI includes a remote application, wherein the local content includes a local file, and wherein the operations further comprise:
in response to selection of the local file for opening by the remote application presented on the UI, redirect the local file to the remote desktop;
open the local file on the remote desktop using the remote application; and
present the local file in a window of the remote application, wherein the window has content of the remote desktop cropped out.

18. The computing device of claim 15, wherein the registered remote desktop component presented on the UI includes the remote desktop, wherein the local content includes a local file, and wherein the operations further comprise:
in response to selection of the local file for opening on the remote desktop presented on the UI, redirect the local file to the remote desktop;
open the local file on the remote desktop using a default remote application installed on the remote desktop; and
present the local file in a window of the default remote application, wherein the window has content of the remote desktop cropped out.

19. The computing device of claim 18, wherein the registered remote desktop component presented on the UI includes a remote folder, and wherein the operations further comprise:
in response to selection of a remote file, in the remote folder presented on the UI, for opening, check the remote desktop to determine if the remote file is located on the remote desktop;
in response to the remote file being located on the remote desktop, open the remote file on the remote desktop using a remote application installed on the remote desktop; and
in response to the remote file being located on some other remote desktop, redirect the remote file to the remote desktop and open the remote file using the remote application installed on the remote desktop.

20. The computing device of claim 15, wherein the operations further comprise:
perform a search on the local OS for local content, including a keyword search; and
present a hitlist that matches the search for local content, wherein the hitlist includes the registered remote desktop component.

21. The computing device of claim 15, wherein the operations further comprise:
monitor the remote desktop for a change in the remote desktop component; and
in response to detection of the change, update the registration of the remote desktop component with the local OS.
